(19) United States
(12) Patent Application Publication
(10) Pub. No.: US 2025/0200480 A1
(43) Pub. Date: Jun. 19, 2025

(54) AUTOMATED WORKFLOW PLATFORM FOR DATA COLLECTION, ANALYSIS, REPORTING, AUDITING, AND CERTIFICATION PROCESSES

(71) Applicant: Parlytix, Inc., Austin, TX (US)

(72) Inventors: William Walker Ryan, Fort Worth, TX (US); Alexander Harmut Duvall, Santa Maria, CA (US)

(73) Assignee: Parlytix, Inc., Austin, TX (US)

(21) Appl. No.: 18/984,092

(22) Filed: Dec. 17, 2024

Related U.S. Application Data
(60) Provisional application No. 63/611,400, filed on Dec. 18, 2023.

(51) Int. Cl. G06Q 10/0637; G06Q 10/067

(52) U.S. Cl. CPC G06Q 10/0637; G06Q 10/067

(57) ABSTRACT

A workflow system may include an interface configured to receive a request, wherein the request includes one or more of a certification request, an audit request, a sustainability report request, or a comparative analysis request. The system may include a controller coupled with the interface and configured to process the request, the controller including: a data collection module configured to determine one or more entities to contact based on the request, to generate a targeted data collection request, to transmit the targeted data collection request, and to collect data; a data modeling module configured to input the data collected into a data model; and a report module configured to receive the data collected from the one or more entities and generate a report based on at least one of the data model or the data collected from the one or more entities.

### CROSS-REFERENCE TO RELATED APPLICATIONS

The present application claims priority to U.S. Provisional Patent Application No. 63/611,400, which is incorporated herein by reference in its entirety.

### TECHNICAL FIELD

The present disclosure relates generally to automated workflows, and in particular, to sustainability, compliance, and/or performance management with automated workflows for data collection, analysis, reporting, auditing, and certification.

### BACKGROUND

Sustainability reporting, certification, and analysis, such as eco-label or environmental certification, involve multiple steps that can vary depending on the type of certification or reporting and the unique circumstances of the applicant's business or product. Thorough documentation of processes, procedures, and compliance is essential for most certifications and reporting requirements. Some organizations may seek external assistance, such as consultants or experts in the certification process, to navigate the complexities of obtaining certifications. Accordingly, there is need for automating the process of obtaining and maintaining certifications as well as conducting broader reporting, competitive analysis, and generating internal insights, thereby helping organizations enhance transparency, improve compliance, increase competitive nature, and generate certifications and/or reports with reduced administrative costs.

The information included in this Background section of the specification is included for technical reference purposes only and is not to be regarded subject matter by which the scope of the present disclosure is to be bound.

### SUMMARY

In at least one example of the present disclosure, a workflow system includes an interface configured to receive a request, wherein the request includes one or more of a certification request, an audit request, a sustainability report request, or a comparative analysis request; and a controller communicatively coupled with the interface and configured to process the request, the controller including: a data collection module configured to determine one or more entities to contact based on the request, to generate a targeted data collection request for the one or more entities, to transmit the targeted data collection request to the one or more entities, and to collect data from the one or more entities; a data modeling module configured to input the data collected from the one or more entities into a data model; and a report module configured to receive the data collected from the one or more entities and generate a report based on at least one of the data model or the data collected from the one or more entities.

In one example, the data model includes a plurality of structured models; and the data modeling module is configured to integrate the data collected from the one or more entities into the structured models. In one example, the report module is configured to generate the report based on at least one structured model of the plurality of structured models; and the report includes at least one certification report, compliance audit, sustainability assessment, or market comparison. In one example, the report includes a description of one or more of a process of the data collection module, a process of the data modeling module, or a process of the report module. In one example, the interface is configured to receive feedback corresponding to the report; the controller is configured to process the feedback; and the report module is configured to generate a revised report based on the feedback. In one example, the sustainability report request includes a desired metric; the data collected from the one or more entities includes data of a system composed of components; and the report includes an optimization recommendation for the system based on the data collected from the one or more entities and the desired metric. In one example, the request further includes a regulation request; and the report includes one or more of a summary of regulatory changes or an optimization recommendation.

In at least one example of the present disclosure, a method for automatically managing workflow includes receiving a request, wherein the request includes one or more of a certification request, an audit request, a sustainability report request, or a comparative analysis request; processing the request to determine a workflow; generating a targeted data collection request according to the determined workflow; collecting data based on the targeted data collection request; inputting the collected data into at least one of a data model or a report module; and generating a report based on at least one of the data collected from the one or more entities or the data model.

In one example, the method further includes: determining one or more entities to contact based on the request; and transmitting, prior to collecting data, the targeted data collection request to the one or more entities via one or more of email, text, or telephone call. In one example, the one or more entities include one or more of an internal party or an external party. In one example, the collected data is from one or more of the following formats: Portable Document Format, Comma Separated Values, Microsoft Excel Open Extensible Markup Language Spreadsheet, Microsoft Word Document, JavaScript Object Notation, Message Queuing Telemetry Transport, Application Programing Interface, Enterprise Resource Planning, Hypertext Markup Language. In one example, the report includes one or more of: a description of one or more of a process of the collecting data step, a process of the inputting the collected data into the data model step, or a process of the generating the report step; a proposal, a product comparison, a compliance report, or an impact analyses; or an environmental product declaration, a health product declaration, or a declare label declaration.

In at least one example of the present disclosure, an automatic workflow system includes an interface; one or more hardware processors communicatively coupled with the interface, wherein the one or more hardware processors are configured by machine-readable instructions to: receive a request, wherein the request includes one or more of a certification request, an audit request, a sustainability report request, or a comparative analysis request; process the request to determine a workflow; determine one or more entities to contact based on the request; generate a targeted data collection request for the one or more entities according to the determined workflow; transmit the targeted data collection request to the one or more entities; collect data from the one or more entities based on the targeted data collection request; input the data collected from the one or more entities into at least one of a data model or a report module; and generate a report based on at least one of the data collected from the one or more entities or the data model.

In one example, the data collected from the one or more entities is in one or more of the following formats: Portable Document Format, Comma Separated Values, Microsoft Excel Open Extensible Markup Language Spreadsheet, Microsoft Word Document, JavaScript Object Notation, Message Queuing Telemetry Transport, Application Programing Interface, Enterprise Resource Planning, Hypertext Markup Language. In one example, the report includes one or more of a scenario analysis or a comparison analysis. In one example, the one or more hardware processors are further configured by the machine-readable instructions to: generate a follow-up data collection request for the one or more entities based on the report; transmit the follow-up data collection request to the one or more entities; collect follow-up data from the one or more entities based on the follow-up data collection request; input the follow-up data collected from the one or more entities into the data model; and generate a revised report based on the data model. In one example, the report includes one or more of: a description of one or more of the data collected from the one or more entities, the data model, or the report; a proposal, a product comparison, a compliance report, or an impact analyses; or an environmental product declaration, a health product declaration, or a declare label declaration. In one example, the report is a certification report and includes one or more of a template, a task tracker, or a task assignor. In one example, the data model is an internal data model or an external data model. In one example, the data model includes a scenario model; and the report includes analyses for design or carbon reduction strategies.

In addition to the exemplary aspects and embodiments described in this Summary, further aspects and embodiments will become apparent by reference to the drawings and by study of the following description. This Summary is not intended to identify key features or essential features of the claimed subject matter, nor is it intended to be used to limit the scope of the claimed subject matter.

### DESCRIPTION OF THE DRAWINGS

Some embodiments of the present disclosure are now described, by way of example only, and with reference to the accompanying drawings. The same reference number represents the same element or the same type of element on all drawings.

FIG. 1A is a block diagram of a workflow system in an example embodiment.

FIG. 1B is a table that lists exemplary internal data inputs.

FIG. 1C is a table that lists exemplary external data inputs.

FIG. 2A is a block diagram of a controller for processing requests in an example embodiment.

FIG. 2B is a block diagram of data model communicatively coupled with a data modeling module of a controller for processing requests in an example embodiment.

FIG. 3 is a flowchart illustrating a method of processing a request in an example embodiment.

FIG. 4 illustrates a processing system operable to execute a computer readable medium embodying programmed instructions to perform desired functions in an example embodiment.

This Brief Description of the Drawings is not intended to identify essential features of the claimed subject matter, nor is it intended to be used to limit the scope of the claimed subject matter. A more extensive presentation of features, details, utilities, and advantages of the present disclosure is provided in the following written description of various embodiments of the claimed subject matter and illustrated in the accompanying drawings.

### DETAILED DESCRIPTION

The figures and the following description illustrate specific example embodiments. It will thus be appreciated that those skilled in the art will be able to devise various arrangements that, although not explicitly described or shown herein, embody the principles of the embodiments and are included within the scope of the embodiments. Furthermore, any examples described herein are intended to aid in understanding the principles of the embodiments, and are to be construed as being without limitation to such specifically recited examples and conditions. As a result, the inventive concept(s) is not limited to the specific embodiments or examples described below, but by the claims and their equivalents.

The following disclosure relates to sustainability, compliance, and/or performance management with automated workflows for data collection, analysis, reporting, auditing, and certification. The various systems described herein may be an artificial intelligence (AI) platform that can unify sustainability, marketing, sales, and research and design (R&D) processes. For example, the AI platform may automate complex tasks by creating a workflow and deliver actionable insights by modeling collected data that link sustainability to business value. The AI platform may enable cross-functional integration, adaptability, and customer engagement focus, which allows the AI platform to embed sustainability as core foundation for business operations. For example, the AI platform may enable business units to address customer needs through personalized sustainability proposals, return on investment analyses for eco-friendly products, and interactive educational tools, which may position sustainability as a value-added service.

The AI platform may perform cross-functional integration and unify data management by linking otherwise siloed business units together by the permeation of data across different departments. For example, the AI platform may centralize data, such as sustainability data, and inhibit or eliminate data silos, which can make information accessible across departments. This unification of data management may increase consistency and efficiency, for example in sustainability efforts. With the data centralized, the AI platform may link or connect traditionally separate departments, such as sustainability, marketing, sales, and R&D, with real-time, data-driven insights tailored to the needs of each department, which can foster collaboration and align organizational efforts. For example, the AI platform may coalesce data from various departments, creating novel data sets that may enable the generation of new insights.

In addition to performing cross-functional integration of internal business units, the AI platform may communicate with entities that are external to the business. By analyzing internal and external data, the AI platform may generate documentation that may inform the various business units regarding both internal and external factors, which can enable business leaders to make more informed decisions regarding the business and enhance their strategic decision-making ability. For example, the AI platform may perform technical tasks, such as carbon footprint calculations, as well as provide high-level strategic insights, such as competitor benchmarking, which provides business units with both operational and strategic support. The insights and support provided by the AI platform may enable non-experts, e.g., business professionals without a deep technical knowledge of the data, to make informed decisions.

The AI platform may generate customized documentation, such as proposals, product comparisons, compliance reports, and impact analyses based on real-time data. For example, the AI platform may evolve by learning from user interactions, adapting recommendations to align with organizational goals and emerging trends in real-time data, enabling relevance over time. Thus, not only is the generation of customized documentation efficient, but the content of the documentation is relevant for specific audiences and industries. For example, the AI platform may link initiatives, such as sustainability initiatives, to business outcomes, such as customer acquisition, competitive positioning, and cost optimization, which may position sustainability as a growth driver rather than merely a compliance measure.

Thus, the AI platform may assist companies with environmental and/or sustainability analysis, product carbon footprints, life cycle assessments, environmental product declarations, health product declarations, declare labels, certifications, and the like. To assist companies with this, the AI platform may generate or perform workflow management, data requests, data collection, data transformation, data reporting, modeling and analysis, product system optimization, comparative analysis, reports or documentation, third party auditing, and certifications.

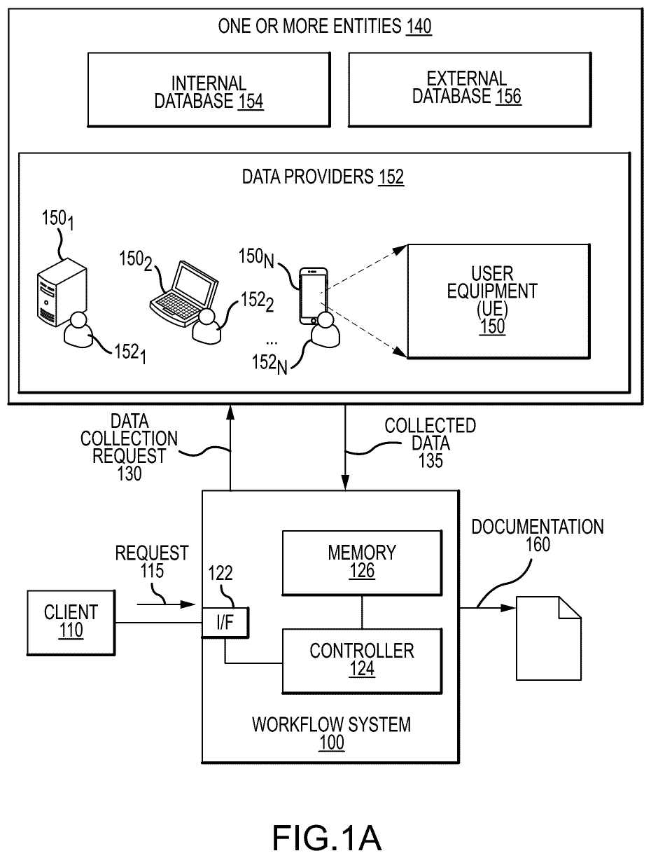

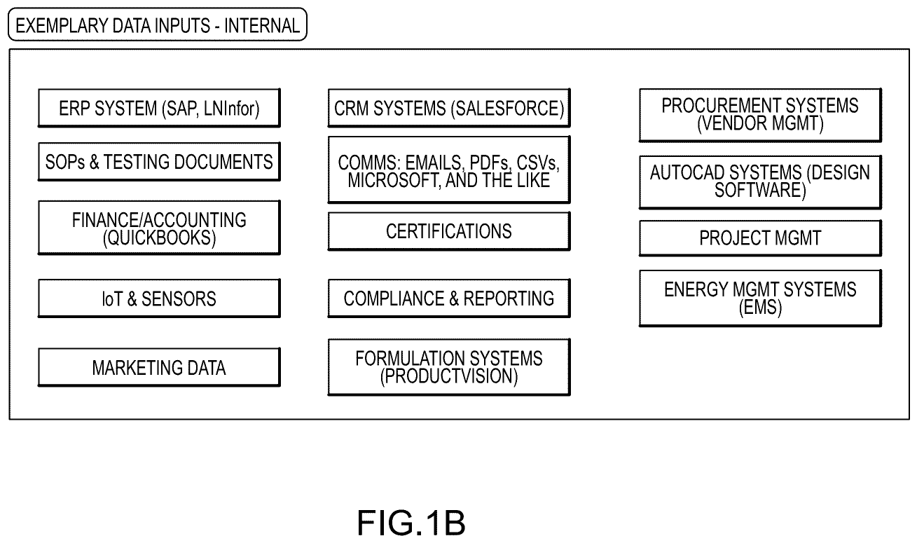

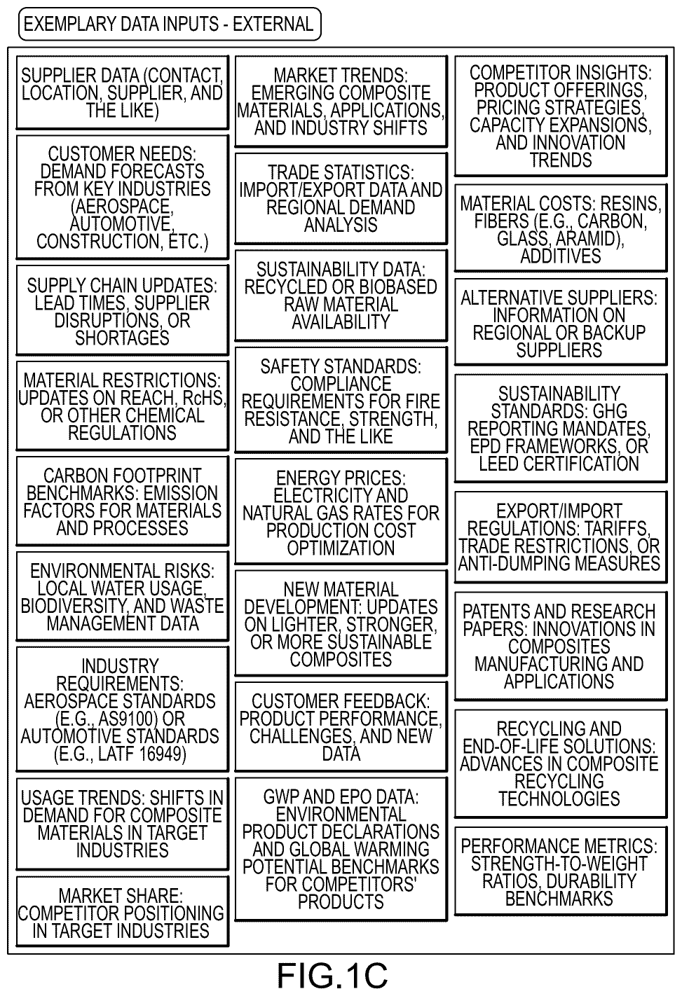

FIG. 1A is a block diagram of a workflow system 100 in an example embodiment. For example, the workflow system 100 may be a sustainability management workflow system and may encompass certification processing, reporting, auditing, data analysis, competitive comparison, and sales enablement tools. The workflow system 100 may receive a request 115 from a client 110, e.g., through a client-facing user interface, process the request 115 in a sequence of steps or create a workflow, and output documentation 160. The created workflow may include gathering or generating project templates and/or tracking the status of gathered or generated tasks, each related to the request 115. In general, the workflow system 100 provides tools to help the client 110 gather, analyze, and report data to streamline various processes and tasks, such as a certification process, deliver competitive analysis, and generate internal insights. Embodiments disclosed herein can take the form of software, hardware, firmware, or various combinations thereof. In one example, software is used to direct the workflow system 100 to perform the various operations disclosed herein.

The client 110 may be part of an organization seeking to achieve and maintain an environmental, compliance, or supply chain certification or data set. Workflow system 100 may operate to automate the steps for obtaining certification, including coordinating the data collection process from one or more entities 140, such as data providers 152 and databases 154, 156. A data provider 152 may include an individual or entity such as a stakeholder that is internal to the organization of the client 110 or a third party or vendor that is external to the organization of the client 110. For instance, for certain types of environmental certifications, an organization may desire to substantiate their claims of sustainable sourcing using evidence provided from third-party suppliers.

Workflow system 100 includes an interface (I/F) 122, e.g., an Ethernet interface, wireless interface, or the like. The interface 122 may receive a request 115, e.g., from the client 110. The request 115 may be or may include a certification request, an audit request, a sustainability report request, a comparative analysis request.

Exemplary certification requests may include an environmental product declaration request, a health product declaration request, a declare label declaration request, a GREENGUARD Certification request, and the like. Exemplary audit requests may include requests for material and chemical transparency audits (e.g., HPD and Declare Label audits), requests for environmental impact audits (e.g., lifecycle analysis audits), and the like. Exemplary sustainability report requests may include an environmental model refresh request, a product carbon footprint request, a corporate sustainability report request, and the like. Exemplary comparative analysis requests may include a competitor product look up request, a material sustainability optimization request, and the like.

The request 115 may also include associated data provided by the client 110. For example, the associated data may be or may include supplementary data provided by the client 110 that is related to the request 115, such as specific raw materials or energy usage.

In one example, the request 115 may correspond to product identification related to sustainability, e.g., the request 115 may be a sustainability report request and/or a comparative analysis request. For example, the request 115 may be input into the interface 122 by the client 110 as, “A coating product with volatile organic compounds limits for Leadership in Energy and Environmental Design compliance.” Enabled by the components and processes described herein, such as the AI system 210, the workflow system 100 may provide a product type, material composition, and intended use. The workflow system 100 may classify the product using natural language processing on descriptions and map the product to existing product databases. For example, the workflow system 100 may categorize a product as a “low-volatile organic compounds paint” for benchmarking.

In one example, the request 115 may correspond to product sustainability, e.g., the request 115 may be a sustainability report request. For example, the request 115 may be input into the interface 122 by the client 110 as, “Prove a carbon footprint report for Product A.” Enabled by the components and processes described herein, such as the AI system 210, the workflow system 100 may provide a carbon footprint report for Product A.

In one example, the request 115 may correspond to life cycle inventory data points, e.g., the request 115 may be a sustainability report request and/or a comparative analysis request. For example, the request 115 may be input into the interface 122 by the client 110 as, “Electricity mix (renewable vs. non-renewable) in specific regions.” Enabled by the components and processes described herein, such as the AI system 210, the workflow system 100 may provide available life cycle inventory data for materials, energy usage, and transportation.

In one example, the request 115 may correspond to a new product with minimal, e.g., not adequate, customer data, e.g., the request 115 may be a sustainability report request and/or a comparative analysis request. For example, the request 115 may be input into the interface 122 by the client 110 as, “Assess environmental impact of terrazzo”, which is a newly designed flooring material. Enabled by the components and processes described herein, such as the AI system 210, the workflow system 100 may predict missing data for raw materials and production, benchmark the data against similar material products, and calculate and generate a life cycle impact assessment. The life cycle impact assessment may include for example, global warming potential, ozone depletion potential, and the like. The AI system 210 may generate and run life cycle impact assessment models, which may be or may include environmental profiles showing emissions across raw materials, transportation, and production. For example, a greenhouse gas profile that breaks down emissions by scope and activity. The workflow system 100 may use trained models, e.g., the data modeling module 240, on regional and industry-specific factors. In these examples, the workflow system 100 may generate a recommendation to adjust packaging material emissions based on weight and material type, considering recycling rates in specific geographies.

Similarly, in another example, the request 115 may correspond to data imputation for missing inputs, e.g., the request 115 may be a comparative analysis request. Enabled by the components and processes described herein, such as the AI system 210, the workflow system 100 may predict missing data points based on trained models and public datasets. For example, the workflow system 100 may estimate global warming potential for a product where the supplier hasn't disclosed emissions, using data from similar materials in the same region.

In one example, the request 115 may correspond to optimizing a supply chain, e.g., the request 115 may be a sustainability report request and/or a comparative analysis request. For example, the request 115 may be input into the interface 122 by the client 110 as, “Find the most sustainable supplier for raw aluminum”. Enabled by the components and processes described herein, such as the AI system 210, the workflow system 100 may identify suppliers, incorporate transport distances, and assesses emissions for regional energy mixes. The workflow system 100 may perform geography and logistics modeling. For example, the AI system 210 may incorporate geospatial data to model shipping routes, transport types, and energy grid mixes, which may enable the workflow system 100 to optimize shipping impacts, for example, by modeling the difference between rail and trucking for the U.S. Midwest.

In one example, the request 115 may correspond to competitive benchmarking, e.g., the request 115 may be a comparative analysis request. For example, the request 115 may be input into the interface 122 by the client 110 as, “Compare company A's new adhesive to existing market leaders”. Enabled by the components and processes described herein, such as the AI system 210, the workflow system 100 may model both company A's and competitors' products, benchmark impacts, and identify emission reduction opportunities.

In another example, the request 115 may similarly correspond to comparative benchmarking, e.g., the request 115 may be a comparative analysis request. For example, the request 115 may be input into the interface 122 by the client 110 as, “Compare the carbon footprint of a new epoxy against standard adhesives”. Enabled by the components and processes described herein, such as the AI system 210, the workflow system 100 may collect and synthesize publicly available data on comparable products, such as Environmental Product Declarations, life cycle assessments, or market intelligence. The workflow system 100 may match the analyzed product against comparable public data for emissions, raw materials, and costs. For example, the workflow system 100 may benchmark greenhouse gas emissions against the median value of competing products, and highlight or otherwise note areas for improvement, e.g., where the greenhouse gas emissions may be greater than the median value of competing products.

In another example, the client 110 may compare products, e.g., any number of products to each other, e.g., the request 115 may be comparative analysis request. In this example, the client 110 may compare Product 1 and Product 2 and may upload files corresponding to Product 1 and files corresponding to Product 2 and, optionally, any additional content. The workflow system 100 may populate sections, such as a Comparison section, a Document Summary section, and an Analysis section, with information and insights based on the uploaded files and additional data pulled from other platforms, such as the internal database 154 and the external database 156. For example, the Comparison section may include information pulled from external sources such as technical specifications, such as Product Type, Red List information, Density (lbs/gal), and the like for both Product 1 and Product 2. The client 110 may customize the Comparison section based on information desired for Product 1 and Product 2. The Document Summary section may include source information regarding the filed uploaded by the client 110, such as name, type, and summary of the files. The Analysis section may include an overview write up comparing Product 1 and Product 2, for example may summarize factors related to the products' environmental impact and sustainability and may summarize advantages related to the factors. For example, a factor may be, “Volatile Organic Compounds Content Range (g/L)” and workflow system 100 may list that the range of Product 1 is less than 5 g/L and the range of Product 2 is less than 50 g/L. The workflow system 100 may summarize the advantage as “Product 1 contains significantly lower volatile organic compounds, making it a healthier choice for indoor air quality and contributing to a more sustainable environment.”

The workflow system 100 may also provide a Live Questions section to the client 110 where the client 110 may provide feedback or ask questions and the workflow system 100 may update the analysis or provide additional information accordingly. For example, the client 110 may input in the Live Questions section, “Compare the two products pricing on a per gallon basis.” The workflow system 100 may list the data pulled, such as the price per gallon of each product, provide a pricing comparison, which may account for any real-time discounts, and generate a conclusion, such as “On a per gallon basis, Product 1 is more cost-effective at $20.80 per gallon compared to either the base price or the discount price of Product 2. At the discount price, Product 2 is slightly more expensive at $26.49 per gallon.”

Workflow system 100 may include a controller 124 or may be in communication with the controller 124. For example, the controller 124 may be electrically or wirelessly coupled with the workflow system 100 and the components thereof. In other examples, the controller 124 may be a component of the workflow system 100, as depicted in FIG. 1A. The controller 124 may be implemented as custom circuitry, a processor executing programmed instructions, and the like. For example, the controller 124 may be or may include one or more hardware processors configured by machine-readable instructions to perform the various functions described herein.

The controller 124 may be communicatively coupled, e.g., operably coupled, with the interface 122. With the controller 124 communicatively coupled with the interface 122, the controller 124 may process the request 115 and may determine or generate a workflow. For example, the request 115 may be a certification request. To obtain an environmental or sustainability certification, there are a complex set of tasks and rules. The workflow system 100 may generate a workflow including templates, task tracking, task assignment, and the like. The workflow system 100 may follow or perform actions corresponding to the workflow, e.g., populate the template, and/or transmit actions corresponding to the workflow to the client 110 or a third party for complete, e.g., task assignment.

In accordance with the determined workflow, the controller 124 may communicate with the one or more entities 140, such as internal and/or external entities. Thus, in response to receiving the request 115, the workflow system 100 may determine which of the one or more entities 140, such as data providers 152 and/or databases 154, 156, to contact according to information provided in or with the request 115. The external database 156 may be or may include Infor LN ERP, SAP ERP, and the like.

The workflow system 100 may generate at least one data collection request 130, e.g., according to the determined workflow, and transmit the data collection request 130, e.g., to the one or more entities 140. In this way, the data collection request 130 may be a targeted data collection request since the data collection request 130 is for a specific entity with specific data requests for that entity. The workflow system 100 may transmit the data collection requests 130 to user equipment (UE) 150 (e.g., computer, phone, email, etc.) of each user or provider of the data providers 152. For example, the workflow system 100 may transmit the data collection request 130 via email, text, and/or telephone call. The workflow system 100 may pull or extract data from at least one database, such as at least one internal database 154 and/or at least one external database 156.

In doing so, workflow system 100 may collect data, e.g., collected data 135, from the one or more entities 140, which may be based on the data collection request 130. Since the one or more entities 140 may be an internal and/or external entity, the collected data 135 or data inputs may also be internal and/or external. For example, FIG. 1B lists exemplary internal data inputs that the collected data 135 may be or may include, and FIG. 1C lists exemplary external data inputs that the collected data 135 may be or may include. For example, with the request 115 including a certification request, the collected data 135 may include environmental impact data, performance metrics, product attributes, and other information required for the certification. The collected data 135 may be in, and the workflow system 100 may ingest data that is in, one or more of the following formats: Portable Document Format, Comma Separated Values, Microsoft Excel Open Extensible Markup Language Spreadsheet, Microsoft Word Document, JavaScript Object Notation, Message Queuing Telemetry Transport, Application Programing Interface, Enterprise Resource Planning, Hypertext Markup Language, and the like.

The workflow system 100 may ingest data from one or more of the following systems: enterprise resource planning systems (e.g., SAP), customer relationship management systems (e.g., Salesforce), procurement systems, market trends, competitor insights, IoT sensors, certifications, financial systems, compliance standards, external sources, and the like. For example, the workflow system 100 may ingest data from external sources through direct integrations, application programming interfaces, direct database queries that may provide structured tables, and the like. The collected data 135 from one or more of the aforementioned systems may be used to generate the documentation 160, e.g., generated in response to a request 115. For example, the request 115 may include a certification request and the collected data 135 from one or more of the aforementioned systems may be used for the certification and for additional processing and insight generation included in the documentation 160.

Regarding enterprise resource planning systems, the data types may include inventory levels, production schedules, energy usage per production unit, material costs, waste outputs, and the like. The formats may include Comma Separated Values; Microsoft Excel Open Extensible Markup Language Spreadsheets, e.g., from SAP modules; application programming interface integrations, .e.g., delivering JavaScript Object Notation or Extensible Markup Language data; and the like. For example, the data may be or may include monthly production energy consumption reports, real-time tracking of raw material usage for specific product lines, and the like.

Regarding customer relationship management systems, the data types may include customer interaction history, sales pipelines, account sustainability goals, customer preferences, and the like. The formats may include Salesforce reports, e.g., in Comma Separated Values or Microsoft Excel Open Extensible Markup Language Spreadsheets; application programming interface responses, e.g., in JavaScript Object Notation format; embedded dashboards or widgets exporting summarized insights; and the like. For example, the data may be or may include queries on customers requesting sustainable products, historical deal data indicating the impact of sustainability on sales outcomes, and the like.

Regarding procurement systems, the data types may include supplier data; material specifications; vendor certifications, e.g., Forest Stewardship Council, Energy Star, and the like; purchase order history; and the like. The formats may include supplier certifications, e.g., in Portable Document Formats; supplier certifications; supplier-specific Comma Separated Values exports; application programming interface feeds, Electronic Data Interchange transactions; and the like. For example, the data may be or may include supplier compliance with carbon footprint thresholds, historical costs associated with eco-certified suppliers, and the like.

Regarding market trends, the data types may include industry benchmarks, consumer preference surveys, competitor sustainability efforts, regulatory updates, and the like. The formats may include market research reports, e.g., in Portable Document Format or Hypertext Markup Language; web scraping or RSS feeds delivering, for example, Hypertext Markup Language, JavaScript Object Notation, Extensible Markup Language; application programming interface feeds, e.g., from industry-specific databases like IBISWorld or Gartner; and the like. For example, the data may be or may include real-time market signals indicating shifts toward low-global warming potential materials, summaries of legislation impacting the building materials industry, and the like.

Regarding competitor insights, the data types may include Product Environmental Product Declarations, product lists, technical specifications, safety specifications, product overviews, claims, innovation announcements, patent filings, and the like. The formats may include competitor Environmental Product Declarations, e.g., in Portable Document Formats; scraped content from websites or structured application programming interfaces from market intelligence platforms; summaries from competitor earnings calls or sustainability reports; and the like. For example, the data may be or may include competitor product comparison data for carbon emissions, analysis of competitor investments in renewable energy, and the like.

Regarding IoT sensors, the data types may include real-time energy consumption, machinery efficiency, production downtime, emissions tracking, and the like. The formats may include JavaScript Object Notation or Extensible Markup Language, e.g., from IoT gateways; message queuing telemetry transport data streams; time-series databases, e.g., InfluxDB, Comma Separated Values downloads, e.g., from proprietary IoT dashboards; and the like. For example, the data may be or may include live data streams monitoring carbon dioxide emissions during production, time-stamped energy efficiency readings from manufacturing equipment, and the like.

Regarding certifications, the data types may include green building certifications, e.g., Leadership in Energy and Environmental Design, WELL; environmental impact assessments; product-specific certifications, e.g., Forest Stewardship Council, Green Seal; and the like. The formats may include Portable Document Formats or scanned documents, e.g., from certifying bodies; application programming interfaces delivering structured certification data, e.g., UL's SPOT database; spreadsheet summaries of certified product lists; and the like. For example, the data may be or may include certification details for Leadership in Energy and Environmental Design-compliant materials, a summary of active versus expired certifications in a product portfolio, and the like.

Regarding financial systems, the data types may include operational costs, cost-benefit analyses of initiatives, such as sustainability initiatives, financial incentives, such as penalties tied to emissions, and the like. The formats may include Excel exports, e.g., from accounting systems; application programming interface feeds, e.g., from systems such as QuickBooks, Oracle Financials, and the like; enterprise resource planning financial module integrations delivering structured data; and the like. For example, the data may be or may include return on investment calculations for switching to renewable energy sources, cost analyses linking material choices to sustainability incentives, and the like.

Regarding compliance standards, the data types may include regulatory thresholds, e.g., greenhouse gas limits; safety standards; environmental impact limits; and the like. The formats may include text from government regulations, e.g., in Portable Document Format, Hypertext Markup Language, and the like; application programming interfaces from compliance tracking platforms, e.g., Assent Compliance; Comma Separated Values, Excel imports, and the like summarizing compliance adherence by region; and the like. For example, the data may be or may include regional limits on volatile organic compounds content in paints, alerts for upcoming deadlines on mandatory sustainability reporting, and the like.

Moreover and described in more detail herein, the workflow system 100 may include AI tools, e.g., AI system 210, to dynamically adapt its workflow steps, including adding or removing steps and/or changing the sequence of the current workflow or a subsequent request/workflow, to improve its processes. Additionally, workflow system 100 leaves an auditable data trail to meet the standards of documentation, data management, compliance tracking, e.g., for a certification, educational material, and the like.

The workflow system 100 may include a memory 126 (e.g., Random Access Memory (RAM), a hard disk, etc.). The memory 126 may be communicatively coupled, e.g., operably coupled, with or to the controller 124. For example, the memory 126 and the controller 124 may be electrically or wirelessly coupled. The memory 126 may store the request 115 and the associated data, e.g., provided by the client 110.

The workflow system 100 may include other components (not shown), which may be or may include wires, logic boards, electronic connections and flexes, or any other electronic or non-electronic component. The other components may be utilized by the controller 124 for operation.

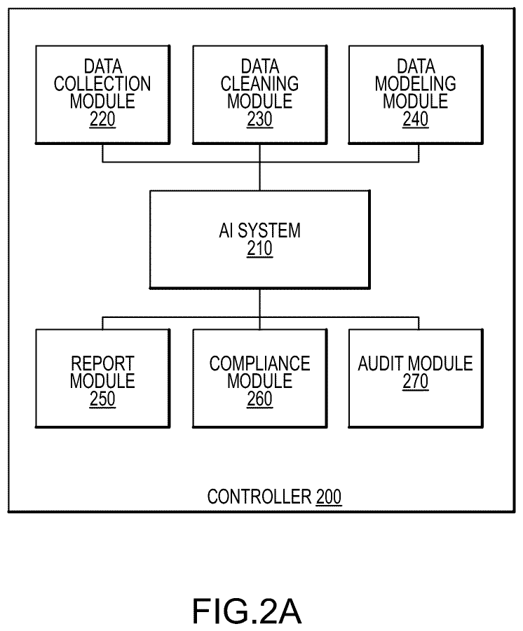

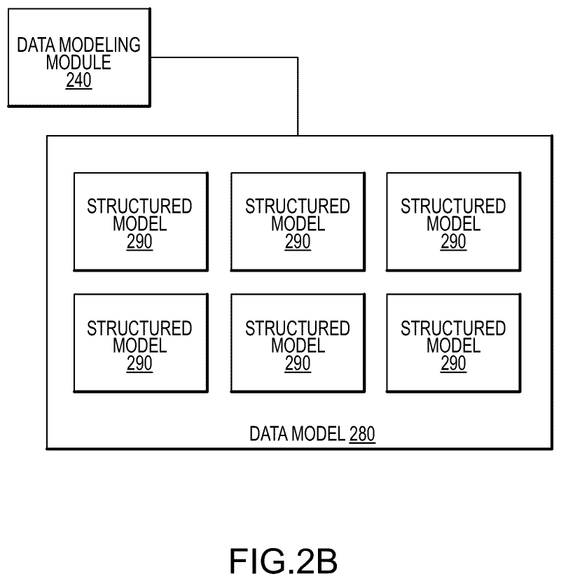

FIG. 2A is a block diagram of a controller 200 for processing requests, such as the request 115, in an example embodiment. The controller 200 may be similar to or the same as the controller 124. The controller 200 includes an AI system 210. The AI system 210 may be an AI machine, mechanism, or algorithm such as a machine learning model that is an unsupervised machine learning algorithm or a server-based machine learning engine. The AI system 210 may be communicatively, e.g., operably, coupled with components of the controller 200, such as electrically or wirelessly, for example via a wireless communication link. The wireless communication link may include an internet connection enabled by one or more communication components of the controller 200 (not shown). The AI system 210 may coordinate and provide features or data for the components of the controller 200, e.g., modules that carry out the functions of the controller 200. In particular, the controller 200 may include one or more of a data collection module 220, a data cleaning module 230, a data modeling module 240, a report module 250, a compliance module 260, and an audit module 270. The AI system 210 may request and collect data, interpret the collected data, and provide insights on the collected data using the modules 220, 230, 240, 250, 260, 270.

The data collection module 220 may identify relevant entities and generate the data collection request 130, transmit the data collection request 130, and collect all relevant data (the collected data 135) from the one or more entities 140. For example, the data collection module 220 may determine one or more entities 140 to contact, e.g., based on the request 115. The data collection module 220 may generate a data collection request 130, as depicted in FIG. 1A among others. For example, the data collection module 220 may generate a targeted data collection request for the one or more entities 140. The data collection module 220 may transmit the data collection request 130, e.g., to the one or more entities 140. The data collection module 220 may collect data, e.g., from the one or more entities 140. In some examples, the data provider 152 or the client 110 may submit a template, which may be specific to the request 115, e.g., a particular type of certification, that indicates what information should to be collected, who to collect the information from (name, phone number, email, and the like), and/or when the information should be collected by. Data collection module 220 may process the submitted template, compile information required from each individual party, and aggregate the data requests so the one or more entities 140 receives a single data collection request 130 for one or more products at a time. In some cases, data collection module 220 may throttle the data collection request 130 to individuals so only limited information is requested at one time. Data collection module 220 handles reaching back out for additional data collection request 130 to these same individuals until all data is collected.

Data collection module 220 may request information from internal or external entities, such as third parties. For instance, organizations seeking certification for sustainable sourcing, responsible procurement, or supply chain management may desire to collect data from their suppliers. In another example, for certifications related to environmental sustainability, organizations may desire to gather environmental impact data from third-party sources such as life cycle assessment data.

Leveraging the AI system 210, the data collection module 220 may follow up with the one or more entities 140, such as third party contacts, via email, text, or phone call, video call, or any other digital communication mechanism. For example in some cases, the one or more entities 140 may not provide sufficient or adequate data and/or more data is desired. In these cases, the data collection module 220 may generate a follow-up data collection request 130 for the one or more entities 140, e.g., based on the analysis of the data by AI system 210, e.g., the data modeling module 240; the documentation 160; or the like. The data collection module 220 may transmit the follow-up data collection request 130 to the one or more entities 140. The data collection module 220 may collect follow-up data, e.g., collected data 135, from the one or more entities 140 based on the follow-up data collection request 130. The data collection module 220 may input the follow-up collected data 135 from the one or more entities 140 into the data cleaning module 230, the data modeling module 240, and/or the report module 250. For example, the data collection module 220 may input the follow-up collected data 135 into a data model 280, as described further herein, of the data modeling module 240. The data collection module 220 may generate new documentation 160, e.g., a revised report, based on the data model 280, as described further herein.

Data collection module 220 may also automatically respond to any questions the one or more entities 140 may have; attempt to reach out to alternate entities or contacts as necessary to obtain the information or data, e.g., via third party or public databases such as LinkedIn, ZoomInfo, and the like; notify a human-in-the-loop for updates or assistance; and the like. The data collection module 220 may continue to reach out to the one or more entities 140 or additional entities for additional data using additional data collection requests 130 until a sufficient amount of data is collected.

Data cleaning module 230 may check and clean the collected data 135 prior to the data modeling module 240 modeling the collected data 135. For example, the AI system 210 may input the collected data 135 directly into the data cleaning module 230. The data may be structured or unstructured and independent of the data format, the data cleaning module 230 may analyze the data, clean the data, verify the accuracy of the data, e.g., through a third party verifier, internally benchmarking against similar products, internal logical checks (e.g., mass balance flows), and normalize the data, all which enable increased data consistency. For example, the data cleaning module 230 may perform data normalization, which may include normalizing data from disparate sources to a database or model, e.g., of the data modeling module 240, the documentation 160, or to a third party for verification; utilizing scripts to extract structured data; generating a form which may be used for manual normalized data entry; and the like. In some examples, the AI system 210 may transmit the collected data 135 directly to a third-party verifier.

Further, in conjunction with the data collection module 220, the data cleaning module 230 may contact any contacts or entities with any questions, clarification requests, additional requests, and the like. Leveraging AI system 210, data cleaning module 230 may parse and ingest documents or tabular data provided using optical character recognition (OCR), large language models (LLMs), machine learning (ML), or other AI tools. Data cleaning module 230 may also use pipelines provided by the AI system 210 to categorize text into discrete input categories, unit normalizations, or any other extract, transform, load (ETL) process. After data cleaning module 230 receives, checks, and verifies the information request responses, the information may be integrated into the data modeling module 240 and/or the report module 250.

The AI system 210 facilitates data exchange across systems, e.g., modules 220, 230, 240, 250, 260, 270, and thus may integrate the data from the data cleaning module 230 into the data modeling module 240. In other examples, the AI system 210 may input the collected data 135 directly into the data modeling module 240 from the data providers 152. The data modeling module 240 may input the collected data 135, e.g., from the data providers 152 or from the data cleaning module 230, into a data model 280, as depicted in FIG. 2B among others. For example, the data modeling module 240 and the data model 280 may be communicatively coupled, e.g., operably coupled.

The AI system 210 may use the data to perform modeling exercises via the data modeling module 240. The data model 280 may be an internal data model and/or an external data model. For example, the data modeling module 240 may be or may include an external data model such as Excel, Google sheets, environmental software, pricing models, SimaPro, OpenLCA, modeling logic of a Python codebase, and the like. In this example, the AI system 210 may operate the third-party modeling software independently. In another example, the data modeling module 240 may be or may include an internal data model and the AI system 210 may model the data independent of an external data model or in addition to an external data model. In this example, the data modeling module 240 may generate custom model calculation requirements managed via logic injection using Colab. Model calculations may include comparative simulations, e.g., using Brightway; official calculations to be submitted for verification using SimaPro; and the like. Thus, using the data modeling module 240, the AI system 210 may run scenario analysis, comparison analysis, identify anomalies in the data, and re-request information based on model results. The AI system 210 may promote quality assurance and control regarding the data results against competitors and publicly available information. For example, information regarding similar products to a product included in the request 115 may be extracted from EC3 and other similar sources. The AI system 210 may compare the information regarding similar products to the information generated by the data model 280. The AI system 210 learns over time with the more data modeled and the ability to spot inaccuracies increases with each use. For example, the AI system 210 may confirm that mass balances, general parameter values, and other holistic measurements are within an allowable range based on past reports and past collected data. An allowable range may be determined by holistic results generated based on the data model 280 may be greater than or equal to about 25 percent and less than or equal to about 25 percent of the average holistic results of similar products. Broader holistic results across similar product systems and families are also benchmarked for comparison purposes within an uncertainty range of plus or minus 50 percent.

The data model 280 may include a plurality of structured models 290 and the data modeling module 240 may integrate the collected data 135 into at least one structured model of the plurality of structured models 290. For example, the plurality of structured models 290 may correspond to the request 115 and may include a certification structured model, a compliance audit structured model, sustainability assessment structured model, a market comparison structured model, and/or a scenario structured model.

The data modeling module 240 may enable the generation of the documentation 160. For example, the data modeling module 240 may generate a structured representation of data and its relationships. In some examples, data modeling module 240 may receive model inputs via a template which guides an analyst for mapping data requests to model inputs and providing any known data. Data modeling module 240 may execute a data model if all inputs are available, including estimated values, and/or each time data is updated. As additional data is added to the system, data modeling module 240 may rerun the model and provide step change indications to the analyst. Additionally, as “primary” or “secondary” data is added to the system, data modeling module 240 can indicate to the analyst how the primary data is impacting the model and suggest areas to focus on that will have the highest impact to modeling impacts, e.g., recommend where to focus effort on the modeling side and preview model changes to guide the analyst. After receiving all model inputs from third parties, data modeling module 240 may model the necessary outputs associated with the request 115 using additional information or inputs fed by a user, e.g., historic pricing, comparative pricing, emissions factors, shipping distances, shipping locations, credit ratings, payment terms, comparative environmental products, and the like. Data modeling module 240 may notify the user once the model is completed and ready for review.

The report module 250 may generate documentation 160, such as a report. The documentation 160 may be short or long-form documents describing the data collection process, modeling, and/or analysis. For example, the documentation 160 may be or may include a description of a process of the data collection module 220, such as the data collection process, a process of the data modeling module 240, such as how the collected data 135 was modeled, and/or a process of the report module 250, such as how the collected data 135 was analyzed. The report module 250 of the AI system 210 may generate portions of the documentation 160 using scientific notation. For example, the report module 250 may generate documentation 160 including an environmental model refresh in response to the request 115 including a sustainability report request, a product carbon footprint in response to the request 115 including a sustainability report request, or a competitor product summary in response to the request 115 including a comparative analysis request.

The documentation 160 may be based on the data model 280 generated by the data modeling module 240. For example, the report module 250 may generate a report based on the data model 280. The report module 250 may generate the documentation 160 based on at least one structured model of the plurality of structured models 290 of the data model 280. For example, the documentation 160 may be based on the at least one structured model of the plurality of structured models 290 that the data modeling module 240 integrated the collected data 135 into. For example, the report module 250 may generate documentation 160, e.g., a report, based on the modeling process of the data modeling module 240. In other examples, the AI system 210 may input the collected data 135 directly into the report module 250. For example, the collected data 135 may include qualitative information from the data provider 152 in response to the data collection request 130 reciting, for example, “give the competitive advantages of your product”. The AI system 210 may directly input the response language that is in the collected data 135 in the report module 250 and the report module 250 may include the response language that is in the collected data 135 in the documentation 160. Similarly in other examples, the AI system 210 may input the collected data 135 indirectly into the report module 250. For example, the AI system 210 may input the collected data 135 directly into the data cleaning module 230 and after the collected data 135 is verified and cleaned, the AI system 210 may input the collected data 135 directly into the report module 250. Thus, the report module 250 may receive, e.g., directly or indirectly, the collected data 135. The rendering of the documentation 160 may include the utilization of Latex, which may render individual sections in complete output report Portable Document Formats, or in other examples the utilization of Python code, which may handle publishing the documentation 160 or data model 280 to one or more application programming interfaces.

The documentation 160 may include report sections. For example, the report sections may include project templates generated or retrieved and included in the workflow created during the processing of the request 115. Individual report sections may be updated or overridden, e.g., by the client 110 or a third party. The documentation 160 may be tailored reports for certifications, compliance audits, sustainability assessments, and market comparisons. For example, the documentation 160 may be or may include a certification report, a compliance audit or report, a sustainability assessment or an impact analyses, and/or a market or product comparison. In other examples, the documentation 160 may be or may include a proposal, e.g., for optimization of a system or product. A large language model may be used to provide context on the collected data 135, to generate insights, and to update language in the documentation 160.

In other examples, the documentation 160 may be or may include certifications or information related to obtaining certifications, such as an environmental product declaration, a health product declaration, or a declare label declaration. For example regarding the environmental product declaration, a client 110 may instruct the workflow system 100 to create or start a report. The client 110 may then be prompted to select and/or log into an Enterprise Resource Planning platform, such as Infor, SAP, Dynamics 365, and the like. The AI system 210 may then be enabled to extract or collect data from the selected Enterprise Resource Planning platform. The client 110 may then select a product for the environmental product declaration. The AI system 210 may include additional products similar to or based on the selection of the product by the client 110, which the client 110 may remove if desired. The client 110 may then be prompted to add additional resources, e.g., connect the AI system 210 to different folder systems, such as SharePoint, Google Drive, or a user equipment 150 hard drive. The AI system 210 may present extracted information, which may be reviewed by the client 110, such as design life of the product, the functional units, primary industries the product is used in, and the like. Once the extracted information is confirmed, further data collection may be performed. For example, manufacturing data, installation and disposal data, raw materials data, and transportation to the customer data may be collected. If any additional information is needed, the AI system 210 may assign tasks or request the information from the client 110. Once an adequate amount of data is collected, a life cycle assessment report may be generated. The client 110 may add comments or questions and the AI system 210 may revise the report accordingly. Once the report is finalized, the client 110 may submit the report for verification. Once the third party verification is complete, the client 110 may download the environmental product declaration report.

Thus, the report module 250 may produce comprehensive reports that address certification requirements and support competitive positioning through benchmarking, sales strategies, and sustainability insights. This integrated workflow offers organizations, such as the client 110, a streamlined, automated process to meet complex certification and reporting demands, enhance data transparency, improve compliance, and leverage sustainability insights for competitive advantage.

In some examples, the documentation 160 may be a tailored report including a sustainability assessment and a market comparison, which may provide insights on trends and competitor activities. In some examples, trends may be identified using recurring data patterns in material use, emission hotspots, or regional inefficiencies. For example, the data modeling module 240 may identify that a specific resin consistently results in higher greenhouse gas emissions when sourced from Asia due to longer shipping distances. Thus, a trend may be determined to exist due to hotspot analysis, e.g., recurring emission sources or resource inefficiencies, such as transport-related emissions consistently high due to global sourcing; improvement opportunities, e.g., identifiable areas where adjustments reduce environmental impacts significantly, such as switching to local suppliers; market patterns, e.g., shifts in material use or regulation, such as increased adoption of bio-based polymers over traditional petrochemicals.

The AI system 210 may optimize a system composed of components, e.g., raw materials or finished products, towards a desired metric, e.g., lowest embodied carbon, lowest price, highest Leadership in Energy and Environmental Design credit, and the like. Components may be benchmarked against one another across multiple dimensions to produce comparative literature. The AI system 210 may generate comparative benchmarks, which may include a visualization of how the product compares to industry or competitor averages. For example, the AI system 210 may report that a product has a global warming potential 20 percent lower than the industry average. In another example, the request 115 may be a sustainability report request including a desired metric provided by the client 110. The collected data 135 from the one or more entities 140 may include data of a system composed of the components. The documentation 160, e.g., a report, may include an optimization recommendation for the system based on the collected data 135 and the desired metric. In another example, the AI system 210 may perform iterative optimization, which may be or may include a machine learning feedback loop. For example, the AI system 210 may collect life cycle inventory data points to match the industry norms of the client 110 and improve accuracy over time. For example, the AI system 210 may adjust the energy intensity of aluminum based on client 110 specific fabrication techniques.

In some examples, the documentation 160 may be a tailored report including a sustainability assessment. For example, a request 115, such as a sustainability report request, may include a regulation request and the documentation 160 may be or may include one or more of a summary of regulatory changes or an optimization recommendation. With the documentation 160 including the summary of regulatory changes, the client 110 may be recurrently updated on regulatory changes, which may promote easier compliance with regulations. In some examples, the documentation 160 including a summary of regulatory changes may be based on the compliance module 260, as described herein. The AI system 210 may generate and provide actionable insights, which may include optimization recommendations such as suggesting areas for improvement in sourcing, manufacturing, or transport. For example, the AI system 210 may recommend switching to a supplier closer to the manufacturing site to reduce transport-related emissions.

In some examples, the documentation 160 may be or may include report regarding a scenario analysis or a comparison analysis. For example, the data modeling module 240 may perform a comparison analysis in which quality assurance and quality control of the data results may be implemented by comparing the results against competitors and/or publicly available information. The data modeling module 240 may identify anomalies in the data, and resolve the anomalies, e.g., by requesting clarifications from the data providers 152 or asking the data providers 152 questions. In another example, the data modeling module 240 may perform a scenario analysis using a structured model 290, which may be a scenario model, and the documentation 160 may include analyses for design or carbon reduction strategies. These analyses may be modeled across business departments, integrating sustainability metrics into decision-making processes.

Thus, the report module 250 may compile the relevant collected data 135 that has been structured according to the data model 280. The report module 250 may perform data analysis to verify that the compiled data is accurate, reliable, and aligned with the requirements of the certification. In some embodiments, report module 250 generates and marks up a report for the analyst each time a structured model 290 is run. The report module 250 may format the documentation 160, e.g., report, depending on the request 115. For example, with a certification request, the documentation 160 may be formatted according to certification requirements. Additionally, the report module 250 may summarize the modeled information in any format per a request made by the client 110, e.g., a word processing document, a power point document, science report, internal memo, and the like.

In some examples, the request 115 or the client 110 may specify what standards for report module 250 to follow in generating the documentation 160. Report module 250 may obtain and read standards documents to ensure the documentation 160 conforms to the identified standard, e.g., ISO, GreenBuild, Leadership in Energy and Environmental Design, investment committee, and the like. Additionally, report module 250 may retrieve examples from external sources to verify an aspect of the generated documentation 160 such as validating acceptable data ranges.

After the client 110 views and confirms the accuracy of the documentation 160, the report module 250 may submit the documentation 160 and/or the collected data 135 to a third party. The documentation 160 and/or the collected data 135 may be submitted to a third party for verification, such as ISO standards or standards boards for accreditation purposes, business use cases, such as optimization recommendations, additional analysis, and the like. The controller 200, e.g., the report module 250, may also receive feedback corresponding to the documentation 160, process the feedback, and generate new documentation 160, e.g., a revised report, based on the feedback. For example, report module 250 may implement comments from reviewers into the documentation 160. Alternatively or additionally, report module 250 may rerun the analysis or the structured model 290 based on feedback, e.g., from internal or external parties, and implement the updated outputs back into the documentation 160. Report module 250 may also answer questions related to methodology, modeling, data inputs, and the like.

In the case where a third-party verification or an audit is desired, the AI system 210 may provide the reports and analysis to the appropriate entities. The AI system 210 may communicate directly with the third party to answer questions, implement feedback, and work through the audit or verification process.

### Exemplary Outputs Tailored for Business Units

As described herein, the AI system 210 may output documentation 160 designed to support different business units, enhancing sustainability, operational efficiency, and/or customer engagement.

Outputs tailored for Sustainability Business Units may include outputs related to data collection and management, such as a summary of data collected from suppliers and systems; outputs related to environmental reporting, such as generating Environmental Product Declarations, Carbon Footprints, and compliance reports; outputs related to carbon footprint analysis, such as calculating Scope 1, 2, and 3 emissions and suggests reduction strategies; outputs related to scenario modeling, such as modeling environmental impacts and forecasting sustainability metrics; outputs related to supplier assessments, such as evaluating suppliers' sustainability metrics and risk factors; outputs related to training and knowledge sharing, such as proving sustainability training modules for business uses; outputs related to stakeholder engagement, such as preparing reports for stakeholders and supporting communications; outputs related to product design insights, such as analyzing lifecycle impacts and suggesting design improvements; outputs related to real-time monitoring, such as tracking energy and/or resource usage and sending alerts; outputs related to circular economy, such as identifying recycling opportunities and calculating waste diversion; outputs related to strategic planning, such as assisting in setting sustainability targets and roadmaps; outputs related to customer insights, such as providing insights into product alignment with customer goals; outputs related to benchmarking, such as, comparing sustainability performance with peers; outputs related to financial analysis, such as evaluating cost savings and return on investment of sustainability initiatives; outputs related to policy support, such as drafting position papers and assessing policy impacts; outputs related to collaboration, such as facilitating sustainability initiatives with partners; outputs related to innovation exploration, such as identifying emerging technologies; outputs related to reporting automation, such as automating dashboards and reports; outputs related to risk assessment, such as evaluating sustainability risks; outputs related to internal audits, such as preparing for audits and simulating scenarios; outputs related to certifications, such as assisting with certifications and renewals; and the like.

Outputs tailored for Marketing Business Units may include outputs related to content creation, such as generating sustainability reports, blog posts, and social media content; outputs related to campaign planning, such as recommending campaigns based on sustainability trends; outputs related to product messaging, such as highlighting product sustainability benefits; outputs related to customer engagement, such as tailoring email campaigns to customer preferences; outputs related to brand positioning, such as suggesting ways to position the brand as a sustainability leader; outputs related to data visualization, such as creating infographics and dashboards; outputs related to social monitoring, such as tracking sustainability trends and competitor activity; outputs related to marketing materials, such as developing case studies and sales materials; outputs related to customer feedback, such as designing surveys for customer insights; outputs related to event support, such as generating materials for sustainability events; outputs related to email campaigns, such as automating newsletters on green initiatives; outputs related to certification messaging, such as alerting on certifications and compliance; outputs related to influencer outreach, such as identifying sustainability influencers; outputs related to training, such as educating the business unit on sustainability trends; outputs related to insights, such as providing real-time updates on sustainability opportunities; outputs related to analysis, such as depicting the impact of sustainability initiatives; outputs related to awards and recognition, such as drafting award applications; outputs related to digital advertising, such as creating sustainability-focused ad campaigns; outputs related to automation, such as automating content scheduling; outputs related to cross-team collaboration, such as aligning marketing with sales and sustainability efforts; and the like.

Outputs tailored for Sales Business Units may include outputs related to sales enablement, such as providing product sustainability summaries and competitive analysis; outputs related to customer engagement, such as answering customer sustainability questions and automating proposals; outputs related to lead generation, such as identifying leads interested in sustainability; outputs related to sales pitches, such as aligning product benefits with customer goals; outputs related to product comparisons, such as benchmarking against competitors; outputs related to reporting, such as generating sustainability reports for customers; outputs related to pricing analysis, such as calculating long-term savings from sustainable products; outputs related to process automation, such as automating proposals and follow-up emails; outputs related to customer goal alignment, such as mapping products to customer sustainability goals; outputs related to CRM Integration, such as using CRM data to tailor pitches; outputs related to training, such as educating representatives on sustainability metrics; outputs related to objection handling, such as providing data-driven responses to objections; outputs related to strategic accounts, such as highlighting opportunities for key accounts; outputs related to customer management, such as providing impact reports to customers; outputs related to real-time updates, such as alerting on sustainability trends; outputs related to collaboration, such as translating sustainability data for actionable sales insights; outputs related to event support, such as providing materials for sustainability-focused events; outputs related to deal closure, such as drafting sustainability-specific contract clauses; outputs related to KPI Tracking, such as tracking sales driven by sustainability efforts; outputs related to decision support, such as prioritizing leads based on sustainability focus; and the like.

Outputs tailored for Research and Development Business Units may include outputs related to material selection, such as recommending eco-friendly materials; outputs related to lifecycle assessment, such as performing life cycle assessments and identifying improvement areas; outputs related to compliance support, such as ensuring product compliance with standards; outputs related to product optimization, such as suggesting design changes for sustainability; outputs related to data-driven innovation, such as identifying sustainable manufacturing trends; outputs related to process efficiency, such as recommending reducing energy and waste; outputs related to testing and prototyping, such as simulating product impacts; outputs related to knowledge sharing, such as translating findings for other business units; outputs related to monitoring and alerts, such as tracking compliance and material availability; outputs related to sustainability reporting, such as tracking research and design impact metrics; outputs related to supplier engagement, such as evaluating suppliers for sustainability; outputs related to scenario modeling, such as modeling environmental impacts of design choices; outputs related to industry benchmarking, such as tracking trends and recommending best practices; outputs related to training, such as providing sustainability training; outputs related to goal strategy, such as developing sustainability roadmaps; outputs related to circular economy, such as identifying material recovery opportunities; outputs related to cost optimization, such as calculating return on investment for sustainable materials; outputs related to long-term strategy, such as forecasting future technologies; outputs related to team collaboration, such as sharing findings for sustainability reports; outputs related to real-time support, such as providing guidance on material choices; and the like.

Compliance module 260 may provide on-going support for an organization to adhere to operational standards, e.g., related to certification. As an example, compliance module 260 may provide data model lifecycle management for a published data model having a set lifetime (e.g., five years). Compliance module 260 coordinates updating existing models (e.g., via outreach, model retuning, etc.) to keep them within specification. Leveraging AI system 210, compliance module 260 may use, for example, a large language model (LLM) trained on industry information (e.g., reports, spreadsheets, images, or any other public or private digital documents) to answer questions and generate data. Additionally, compliance module 260 may ingest news feeds and summarize any impacts to existing data models, reports, and/or customers and provide this summary as a data feed.

Audit module 270 may collect and store relevant data and documentation for an audit, as described herein. For example, this may include information related to compliance with certification standards, environmental performance metrics, and other relevant data obtained and generated by workflow system 100, such as during a certification process. Audit module 270 may record actions, changes, and interactions within the controller 200 or workflow system 100. This audit trail serves as a historical record of activities performed for each workflow.

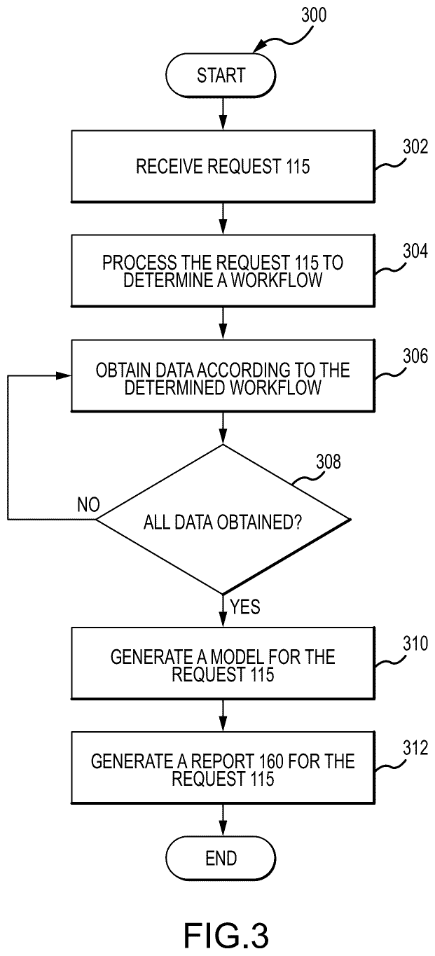

FIG. 3 is a flowchart illustrating a method of processing a request 115 in an example embodiment. The steps of the method 300 are described with reference to the workflow system 100 of FIG. 1A, but those skilled in the art will appreciate that the method 300 may be performed in other systems. The steps of the flowcharts described herein are not all inclusive, may include other steps not shown, and may be performed in an alternative order.

In step 302, the controller 124 may receive a request 115. The request 115 may include one or more of a certification request, an audit request, a sustainability report request, or a comparative analysis request, as described in more detail herein. In step 304, the controller 124 may process the request 115 to determine a workflow. In processing the request 115, the controller 124 may determine one or more entities 140 to contact based on the request 115, such as the data providers 152 and/or the databases 154, 156. In step 306, the controller 124 may generate a data collection request 130, e.g., a targeted data collection request, according to the determined workflow and may collect data, e.g., the collected data 135, based on the data collection request 130. For example, prior to collecting the data, the controller 124 may transmit the data collection request 130 to the one or more entities 140, such as via one or more of email, text, or telephone call. In step 308, the controller 124 may determine whether all data for completing the workflow has been obtained. If not, the method 300 returns to step 306 to continue generating at least one additional data collect request 130. The controller 124 may dynamically alter a subsequent data collection request 130, updating the message or the recipient, if a data collection request 130 is not successful in retrieving the desired information.

After obtaining all data for completing the workflow, the method 300 proceeds to step 310 and the controller 124 may generate or obtain a data model 280 for the request 115 and integrate or input the collected data 135 into the data model 280. And, in step 312, the controller 124 may generate documentation 160, such as a report, for the request 115 based on the data model 280. For example, the request 115 may be a certification request and the data model 280 and/or documentation 160 provided by the controller 124 may be submitted for obtaining the certification in connection with the certification request.

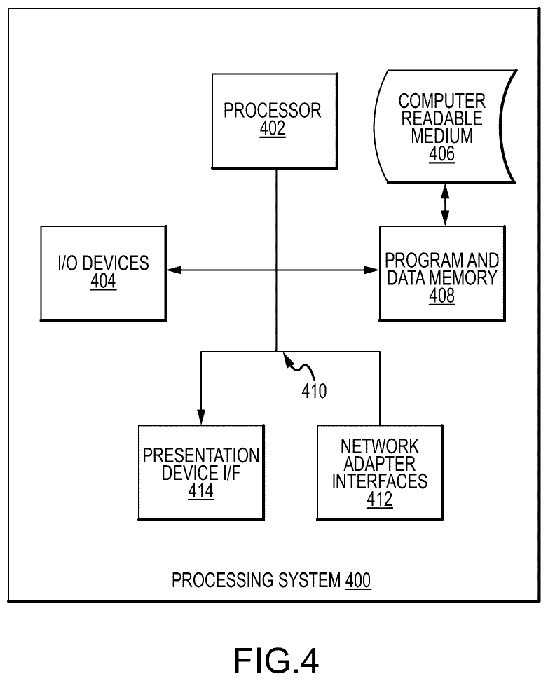

FIG. 4 illustrates a processing system 400 operable to execute a computer readable medium embodying programmed instructions to perform desired functions in an example embodiment. Processing system 400 is operable to perform the above operations by executing programmed instructions tangibly embodied on computer readable storage medium 406. In this regard, embodiments can take the form of a computer program accessible via computer readable medium providing program code for use by a computer or any other instruction execution system. For the purposes of this description, computer readable storage medium 406 can be anything that can contain or store the program for use by the computer.

Computer readable storage medium 406 can be an electronic, magnetic, optical, electromagnetic, infrared, or semiconductor device. Examples of computer readable storage medium 406 include a solid-state memory, a magnetic tape, a removable computer diskette, a random access memory (RAM), a read-only memory (ROM), a rigid magnetic disk, and an optical disk. Current examples of optical disks include compact disk—read only memory (CD-ROM), compact disk—read/write (CD-R/W), and DVD.

Processing system 400, being suitable for storing and/or executing the program code, includes at least one processor 402 coupled to program and data memory 408 through a system bus 410. Program and data memory 408 can include local memory employed during actual execution of the program code, bulk storage, and cache memories that provide temporary storage of at least some program code and/or data in order to reduce the number of times the code and/or data are retrieved from bulk storage during execution.

I/O devices 404 (including but not limited to keyboards, displays, pointing devices, etc.) can be coupled either directly or through intervening I/O controllers. Network adapter interfaces 412 may also be integrated with the system to enable processing system 400 to become coupled to other data processing systems or storage devices through intervening private or public networks. Modems, cable modems, IBM Channel attachments, SCSI, Fibre Channel, and Ethernet cards are just a few of the currently available types of network or host interface adapters. Display device interface 414 may be integrated with the system to interface to one or more display devices, such as screens for presentation of data generated by processor 402.

Although specific embodiments are described herein, the scope of the disclosure is not limited to those specific embodiments. Other examples and implementations are within the scope and spirit of the disclosure and appended claims. Thus, the foregoing descriptions of the specific examples described herein are presented for purposes of illustration and description. They are not targeted to be exhaustive or to limit the examples to the precise forms disclosed. The scope of the disclosure is defined by the following claims and any equivalents thereof.

The word “exemplary” is used herein to mean “serving as an example, instance, or illustration.” Any embodiment described herein as “exemplary” is not necessarily to be construed as preferred or advantageous over other embodiments. The terms “a” or “an” herein are to be construed as open ended, e.g., meaning “at least one”. For example, “X may include a Y” is to be construed as, “X may include at least one Y”, unless specifically stated otherwise. The terms “about” and “substantially” herein are to be construed as +/−10%, unless stated otherwise. Every range of values (of the form, “from about a to about b,” or, equivalently, “from approximately a to b,” or, equivalently, “from approximately a-b” or, equivalently, “greater than about a and less than about b”, for example) disclosed herein is to be understood to set forth every number and range encompassed within the broader range of values. As used herein, directional terms such as “left”, “right”, “above”, “below”, “over”, and “under” can be with respect to an operational orientation of the disclosed systems and methods. As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D.

What is claimed is:

1. A workflow system, comprising:
an interface configured to receive a request, wherein the request includes one or more of a certification request, an audit request, a sustainability report request, or a comparative analysis request; and
one or more controllers or components communicatively coupled with the interface and configured, alone or in combination, to process the request, the one or more controllers including:
a data collection module configured to determine one or more entities to contact based on the request, to generate a targeted data collection request for the one or more entities, to transmit the targeted data collection request to the one or more entities, and to collect data from the one or more entities;
a data modeling module configured to input the data collected from the one or more entities into a data model; and
a report module configured to receive the data collected from the one or more entities and generate a report based on at least one of the data model or the data collected from the one or more entities.

2. The system of claim 1, wherein:
the data model comprises a plurality of structured models; and
the data modeling module is configured to integrate the data collected from the one or more entities into at least one structured model of the plurality of structured models.

3. The system of claim 2, wherein:
the report module is configured to generate the report based on the at least one structured model of the plurality of structured models; and
the report includes at least one certification report, compliance audit, sustainability assessment, or market comparison.

4. The system of claim 1, wherein the report includes a description of one or more of a process of the data collection module, a process of the data modeling module, or a process of the report module.

5. The system of claim 1, wherein:
the interface is configured to receive feedback corresponding to the report;
the one or more controllers are configured, alone or in combination, to process the feedback; and
the report module is configured to generate a revised report based on the feedback.

6. The system of claim 1, wherein:
the sustainability report request includes a desired metric;
the data collected from the one or more entities includes data of a system composed of components; and
the report includes an optimization recommendation for the system based on the data collected from the one or more entities and the desired metric.

7. The system of claim 1, wherein:
the sustainability report request further includes a regulation request; and
the report includes one or more of a summary of regulatory changes or an optimization recommendation.

8. A method for automatically managing workflow, the method comprising:
receiving a request, wherein the request includes one or more of a certification request, an audit request, a sustainability report request, or a comparative analysis request;
processing the request to determine a workflow;
generating a targeted data collection request according to the determined workflow;
collecting data based on the targeted data collection request;
inputting the collected data into at least one of a data model or a report module; and
generating a report based on at least one of the data collected from the one or more entities or the data model.

9. The method of claim 8, further comprising:
determining one or more entities to contact based on the request; and
transmitting, prior to collecting data, the targeted data collection request to the one or more entities via one or more of email, text, or telephone call.

10. The method of claim 9, wherein the one or more entities include one or more of an internal party or an external party.

11. The method of claim 8, wherein the collected data is from one or more of the following formats: Portable Document Format, Comma Separated Values, Microsoft Excel Open Extensible Markup Language Spreadsheet, Microsoft Word Document, JavaScript Object Notation, Message Queuing Telemetry Transport, Application Programing Interface, Enterprise Resource Planning, Hypertext Markup Language.

12. The method of claim 8, wherein the report includes one or more of:
a description of one or more of a process of the collecting data step, a process of the inputting the collected data into the data model step, or a process of the generating the report step;
a proposal, a product comparison, a compliance report, or an impact analyses; or
an environmental product declaration, a health product declaration, or a declare label declaration.

13. An automatic workflow system, the system comprising:
an interface; and
one or more hardware processors or components communicatively coupled with the interface, wherein the one or more hardware processors are configured, alone or in combination, by machine-readable instructions to:
receive a request, wherein the request includes one or more of a certification request, an audit request, a sustainability report request, or a comparative analysis request;
process the request to determine a workflow;
determine one or more entities to contact based on the request;
generate a targeted data collection request for the one or more entities according to the determined workflow;
transmit the targeted data collection request to the one or more entities;
collect data from the one or more entities based on the targeted data collection request;
input the data collected from the one or more entities into at least one of a data model or a report module; and
generate a report based on at least one of the data collected from the one or more entities or the data model.

14. The system of claim 13, wherein the data collected from the one or more entities is in one or more of the following formats: Portable Document Format, Comma Separated Values, Microsoft Excel Open Extensible Markup Language Spreadsheet, Microsoft Word Document, JavaScript Object Notation, Message Queuing Telemetry Transport, Application Programing Interface, Enterprise Resource Planning, Hypertext Markup Language.

15. The system of claim 13, wherein the report includes one or more of a scenario analysis or a comparison analysis.

16. The system of claim 13, wherein the one or more hardware processors or components are further configured, alone or in combination, by the machine-readable instructions to:
generate a follow-up data collection request for the one or more entities based on the report;
transmit the follow-up data collection request to the one or more entities;
collect follow-up data from the one or more entities based on the follow-up data collection request;
input the follow-up data collected from the one or more entities into the data model; and
generate a revised report based on the data model.

17. The system of claim 13, wherein the report includes one or more of:
a description of one or more of the data collected from the one or more entities, the data model, or the report;
a proposal, a product comparison, a compliance report, or an impact analyses; or
an environmental product declaration, a health product declaration, or a declare label declaration.

18. The system of claim 13, wherein the report is a certification report and includes one or more of a template, a task tracker, or a task assignor.

19. The system of claim 13, wherein the data model is an internal data model or an external data model.

20. The system of claim 13, wherein:
the data model includes a scenario model; and
the report includes analyses for design or carbon reduction strategies.
